(19) United States
(12) Patent Application Publication
(10) Pub. No.: US 2016/0185241 A1
(43) Pub. Date: Jun. 30, 2016

(54) VEHICLE AND POWER SUPPLY SYSTEM

(71) Applicant: TOYOTA JIDOSHA KABUSHIKI KAISHA, Toyota-shi (JP)

(72) Inventor: Shigeki KINOMURA, Suntou-gun (JP)

(73) Assignee: TOYOTA JIDOSHA KABUSHIKI KAISHA, Toyota-shi, Aichi-ken (JP)

(21) Appl. No.: 14/910,741

(22) PCT Filed: Aug. 12, 2014
(86) PCT No.: PCT/IB2014/001505

§ 371 Date: Feb. 8, 2016

(30) Foreign Application Priority Data
Aug. 23, 2013 (JP) 2013-173467

(51) Int. Cl. B60L 11/18; B60L 11/02

(52) U.S. Cl. CPC B60L 11/1816; B60L 11/1838; B60L 11/02; Y10S 903/903

(57) ABSTRACT

A vehicle includes a power feeding inverter that converts at least one of power discharged by a storage apparatus and power generated by activating an engine into alternating current power. The vehicle detects the presence of a user within a predetermined range of the vehicle using at least one of a seat occupancy sensor, a camera provided on the exterior or in the interior of the vehicle, and a reception unit that receives ratio waves from a smart key. When a request for power feeding from the vehicle is issued but the user has not been detected within the predetermined range of the vehicle, power generation by activating the engine is prohibited.

### BACKGROUND OF THE INVENTION

1. Field of the Invention

The invention relates to a vehicle and a power supply system, and more particularly to a vehicle having a function of feeding power from the vehicle, and a power supply system including the vehicle.

2. Description of Related Art

A configuration enabling charging of an in-vehicle storage apparatus with power from a power supply on a vehicle exterior (referred to simply as an “external power supply” hereafter), such as a commercial power supply system, has been proposed for use in a vehicle that generates a vehicle driving force using a motor, such as an electric automobile, a hybrid automobile, or a fuel cell automobile. In a conventional so-called plug-in hybrid vehicle, for example, the storage apparatus can be charged from a typical household power supply by connecting a power outlet provided in a house and a charging port connected to the vehicle using a charging cable.

As seen on smart grids and the like, a concept whereby a vehicle that can be charged by an external power supply is used as a power supply source such that power is supplied from the vehicle to a load on the exterior of the vehicle is under investigation in relation to this type of vehicle.

Japanese Patent Application Publication No. 2013-94026 (JP 2013-94026 A) and Japanese Patent Application Publication No. 2013-51772 (JP 2013-51772 A), for example, describe supplying power from a vehicle while generating power by driving an engine.

### SUMMARY OF THE INVENTION

When power is fed from the vehicle by driving the engine, the power can be fed continuously even when a state of charge (SOC) of the storage apparatus decreases. When the engine is activated, however, operating noise and exhaust heat are generated. Therefore, when the engine is activated automatically to start power generation while the user is absent, resulting noise generation and the like may, depending on a parking condition of the vehicle and the time of day, affect the periphery of the vehicle in a manner unintended by the user. This type of situation may occur when, for example, the user moves away from the vehicle during a long power feeding operation, or when power feeding is executed automatically in accordance with a timer or the like.

The invention provides a vehicle and a power supply system with which the periphery of the vehicle is not affected in a manner unintended by a user when power is fed from the vehicle.

A vehicle according to a first aspect of the invention includes: a storage apparatus configured to be recharged; a power generation mechanism configured to generate power using a different energy source from the storage apparatus; a power feeding apparatus configured to supply power obtained from at least one of the storage apparatus and the power generation mechanism from the vehicle; a detector configured to detect a user within a predetermined range of the vehicle; and a controller configured to prohibit power generation by the power generation mechanism when a request for power feeding from the vehicle is issued and the user has not been detected within the predetermined range.

When a state of charge of the storage apparatus is lower than a first determination value and the user has been detected within the predetermined range while a request for power feeding from the vehicle is issued, the controller may activate the power generation mechanism and the power feeding apparatus may feed the power obtained from the power generation mechanism from the vehicle.

When the state of charge exceeds a second determination value, which is larger than the first determination value, while power generation by the power generation mechanism is underway, the controller may stop the power generation by the power generation mechanism and the power feeding apparatus may feed the power obtained from the storage apparatus from the vehicle.

When the state of charge of the storage apparatus is lower than a first determination value and the user has not been detected within the predetermined range, the controller may prohibit power feeding from the vehicle.

The vehicle may further include a connection port configured to electrically connect the vehicle to an exterior located outside the vehicle. The power feeding apparatus may be configured to supply power to the exterior located outside the vehicle through the connection port.

The vehicle may further include a power outlet provided in a vehicle cabin. The power feeding apparatus may be configured to supply power from the power outlet.

The power generation mechanism may include an engine that generates power by burning fuel, and a motor generator that generates power using an output of the engine.

A power supply system according to a second aspect of the invention includes: a vehicle including: a cable connection port, a storage apparatus configured to be recharged, a power generation mechanism configured to generate power using a different energy source from the storage apparatus, a first power feeding apparatus configured to supply power obtained from at least one of the storage apparatus and the power generation mechanism to the cable connection port; a detector configured to detect a user within a predetermined range of the vehicle, and a controller configured to prohibit power generation by the power generation mechanism when the user is not detected within the predetermined range; and a second power feeding apparatus configured to supply power supplied from the vehicle to a load located outside the vehicle, the power feeding apparatus being configured to be electrically connected to the cable connection port via a power cable when a charging/discharging connector provided on the power cable is connected to the cable connection port.

The vehicle may include a power outlet provided in a vehicle cabin, and the first power feeding apparatus may be configured to supply power from the power outlet.

The vehicle may include a charger, and the charger may be configured to convert power supplied to the cable connection port from outside the vehicle via the charging/discharging connector and the power cable into power to be charged to the storage apparatus.

According to these aspects of the invention, effects unintended by the user on the periphery of the vehicle can be avoided when power is fed from the vehicle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view showing a configuration of a vehicle and a power supply system that includes the vehicle, according to an embodiment of the invention;

FIG. 2 is a block diagram illustrating an example of a configuration of the vehicle having a power feeding function shown in FIG. 1;

FIG. 3 is a flowchart illustrating in detail a power feeding operation performed by the vehicle shown in FIG. 2;

FIG. 4 is a flowchart illustrating a control operation performed during power feeding in combination with engine power generation;

FIG. 5 is a conceptual waveform diagram illustrating an operation performed during power feeding in combination with engine power generation; and

FIG. 6 is a conceptual waveform diagram illustrating an operation performed during power feeding in which engine activation is prohibited.

### DETAILED DESCRIPTION OF EMBODIMENTS

An embodiment of the invention will be described in detail below with reference to the drawings. Note that hereafter, identical or corresponding parts of the drawings are allocated identical reference symbols, and description thereof is generally not repeated.

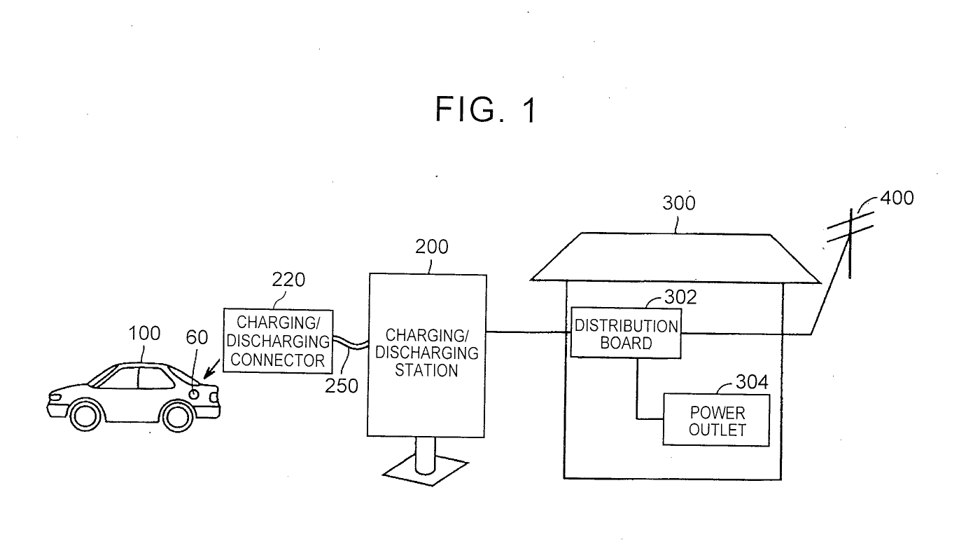

FIG. 1 is a schematic view showing a configuration of a vehicle and a power supply system that includes the vehicle, according to an embodiment of the invention.

Referring to FIG. 1, the power supply system includes a vehicle 100, a charging/discharging station 200, and a distribution board 302 provided in a house 300.

The vehicle 100 is provided with a power cable connection port 60 (referred to hereafter as an inlet 60). A charging/discharging connector 220 provided on one end of a power cable 250 can be connected to the inlet 60.

Another end of the power cable 250 is electrically connected to the charging/discharging station 200. Hence, by connecting the charging/discharging connector 220 to the inlet 60, the inlet 60 is electrically connected to the charging/discharging station 200. The charging/discharging station 200 is typically disposed in the vicinity of a vehicle parking space. Note that when the house 300 and the parking space are close, the charging/discharging station 200 may be disposed in the house, and may be formed integrally with the distribution board 302.

The power supply system is capable of receiving power from a commercial power system 400 in response to a power deficiency, taking into consideration power used by a power outlet 304 provided in the house 300 and power generated by a photovoltaic power generation apparatus, not shown in the drawing, provided on the house. Further, when surplus power is generated, the power supply system can feed (sell) the surplus power to the commercial power system 400.

The vehicle 100 is incorporated into the power supply system by being electrically connected to the charging/discharging station 200 by the power cable 250. As a result, the vehicle 100 can receive power or feed power within the power supply system via the charging/discharging station 200.

Firstly, the vehicle 100 can charge an in-vehicle storage apparatus, to be described below, by receiving power from the commercial power system 400 and/or power generated by the photovoltaic power generation apparatus, not shown in the drawing. By having a user set a timer or the like, for example, the in-vehicle storage apparatus can be charged with inexpensive power from the commercial power system 400 in the middle of the night.

Further, as will be described below, the vehicle 100 is configured to have a power feeding function for outputting an equal amount of power (from 100 to 200 VAC, for example) to the commercial power system 400. In the power supply system shown in FIG. 1, a “power feeding apparatus” for supplying power, from the vehicle 100 to a load located outside the vehicle can be formed from the charging/discharging station 200, the distribution board 302, and the power outlet 304.

Hence, by feeding power to the house 300 from the vehicle 100 during peak hours, peak rates can be avoided. Alternatively, by feeding power from the vehicle 100 during a power outage in the commercial power system 400, the power can be used by the power outlet 304 in the house 300.

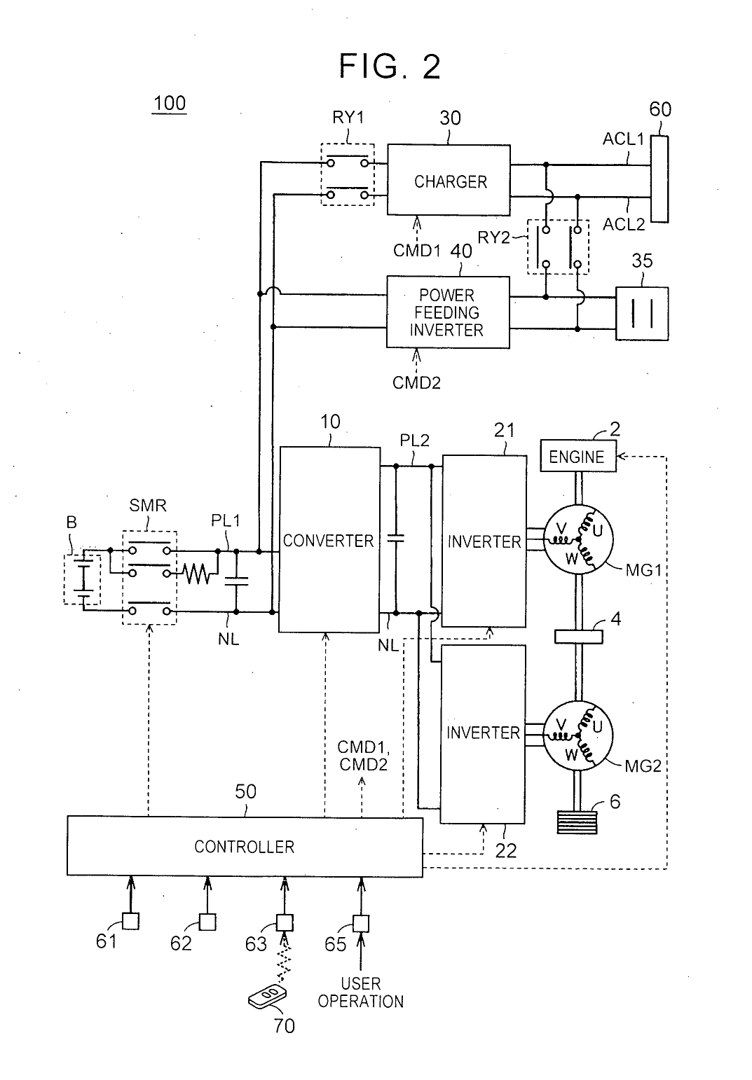

FIG. 2 is a block diagram illustrating an example of a configuration of the vehicle having a power feeding function shown in FIG. 1. In the following embodiment, the vehicle is described as a hybrid vehicle, but the vehicle according to the invention is not limited to a hybrid vehicle.

Referring to FIG. 2, the vehicle 100 includes an engine 2, a motor generator MG1, a motor generator MG2, a power distribution apparatus 4, and a drive wheel 6. The vehicle 100 also includes a storage apparatus B, a system main relay SMR, a converter 10, inverters 21, 22, and a controller 50. The vehicle 100 further includes a charger 30, a power feeding inverter 40, a power outlet 35, the inlet 60, and relays RY1, RY2.

The vehicle 100 is a hybrid vehicle that travels using the engine 2 and the motor generator MG2 as power sources. A driving force generated by the engine 2 and the motor generator MG2 is transmitted to the drive wheel 6.

The engine 2 is an internal combustion engine that outputs power by converting thermal energy generated by burning fuel into kinetic energy of moving elements such as a piston and a rotor. A hydrocarbon based fuel such as gasoline, light oil, ethanol, liquid hydrogen, or natural gas, or liquid or gas hydrogen fuel may be used favorably as the fuel of the engine 2. The engine 2 is configured so that operating conditions thereof, such as a throttle opening (an intake air amount), a fuel supply amount, and an ignition timing, can be controlled electrically by signals from the controller 50.

The motor generator MG1 and the motor generator MG2 are alternating current rotating electric machines, and are constituted by, for example, three-phase alternating current synchronous motors. The motor generator MG1 is used as a power generator that is driven by the engine 2 and as a rotating electric machine that is capable of starting the engine 2. The motor generator MG2 is used as a rotating electric machine that mainly drives the drive wheel 6 of the vehicle 100.

The power distribution apparatus 4 includes a planetary gear mechanism having three rotary shafts, namely a sun gear, a carrier, and a ring gear, for example. The sun gear is coupled to a rotary shaft of the motor generator MG1. The carrier is coupled to a crankshaft of the engine 2. The ring gear is coupled to a drive shaft. The power distribution apparatus 4 divides the driving force of the engine 2 into power to be transmitted to the rotary shaft of the motor generator MG1 and power to be transmitted to the drive shaft. The drive shaft is coupled to the drive wheel 6. The drive shaft is also coupled to a rotary shaft of the motor generator MG2.

The storage apparatus B is a direct current power supply capable of re-discharge, and is constituted by a secondary battery such as a nickel hydrogen battery or a lithium ion battery, a capacitor, or the like, for example. The storage apparatus B supplies power to the converter 10, and is charged by power from the converter 10 during power regeneration.

The system main relay SMR is provided between the storage apparatus B and the converter 10. The system main relay SMR is a relay for controlling electric connection/disconnection between the storage apparatus B and an electric system, and is ON/OFF-controlled by the controller 50.

The inverters 21, 22 are connected to the converter 10 in parallel by a positive electrode line PL2 and a negative electrode line NL. The inverter 21 is connected between the converter 10 and the motor generator MG1. The inverter 22 is connected between the converter 10 and the motor generator MG2. The inverters 21, 22 are controlled by signals from the controller 50.

The converter 10 boosts a voltage from the storage apparatus B, and outputs the boosted voltage to the positive electrode line PL2 and the negative electrode line NL. The inverters 21, 22 drive the respective motor generators MG1, MG2 by converting the direct current voltage output from the converter 10 into an alternating current voltage.

When negative torque (torque in a direction for inhibiting rotor rotation) is output, on the other hand, the motor generators MG1, MG2 generate power. The inverters 21, 22 convert the alternating current power generated by the motor generators MG1, MG2 into direct current power, and output the direct current power to the converter 10. The converter 10 is capable of stepping down the direct current power output from the inverters. 21, 22 to the positive electrode line PL2 and the negative electrode line NL and then outputting the stepped-down direct current power to the positive electrode line PL1 and the negative electrode line NL. As a result, the storage apparatus B can be charged even while the vehicle travels.

The storage apparatus B can also be charged by the charger 30. An input side of the charger 30 is connected to the inlet 60 via power lines ACL1, ACL2. Further, an output side of the charger 30 is connected to the positive electrode line PL1 and the negative electrode line NL via the relay RY1. The relay RY1 is a relay for controlling electric connection/disconnection between the storage apparatus B and the charger 30, and is ON/OFF-controlled by the controller 50.

The charger 30 converts alternating current power supplied to the inlet 60 from outside the vehicle into a direct current voltage on the basis of a signal CMD1 from the controller 50. An output of the charger 30 can be controlled by the controller 50 to a voltage/current suitable for charging the charging apparatus B.

Hence, by electrically connecting the inlet 60 to the commercial power system 400 via the charging/discharging station 200, the storage apparatus B of the vehicle 100 can be charged with power from the commercial power system 400. Note that hereafter, charging of the storage apparatus B with power from outside the vehicle may be referred to as “external charging”.

A direct current side of the power feeding inverter 40 is connected to the positive electrode line PL1 and the negative electrode line NL. An alternating current side of the power feeding inverter 40 is connected to the power outlet 35, and connected to the power lines ACL1, ACL2 via the relay RY2. The relay RY2 is a relay for controlling electric connection/disconnection between the power feeding inverter 40 and the inlet 60, and is ON/OFF-controlled by the controller 50.

The inlet 60 is configured to be capable of doubling as a power feeding port through which power is fed from the vehicle 100 to an external load, a household, or the like, and a charging port through which the vehicle 100 is charged from an external power supply. The inlet 60 corresponds to an embodiment of a “connection port” for establishing electric contact with the exterior located outside the vehicle 100.

The power feeding inverter 40 converts a direct current voltage on the positive electrode line PL1 and the negative electrode line NL into an alternating current voltage and outputs the alternating current voltage on the basis of a signal CMD2 from the controller 50. The output from the power feeding inverter 40 is controlled to a voltage/current suitable for use by an external device. For example, the output voltage of the power feeding inverter 40 is controlled to an equal amount of power (from 100 to 200 VAC, for example) to the commercial power supply 400.

The alternating current power output from the power feeding inverter 40 is output from the power outlet 35. Furthermore, by switching the relay RY2 ON, the alternating current power output from the power feeding inverter 40 can be passed through the inlet 60 and used by the power supply system shown in FIG 1.

By switching the system main relay SMR ON while the vehicle 100 is stationary, the vehicle 100 can output direct current power to the positive electrode line PL1 and the negative electrode line NL. Further, while the vehicle 100 is stationary, the engine 2 can be activated in order to generate power. Power generated by the motor generator MG1 using the output of the engine 2 is converted into direct current power by the inverter 21 and the converter 10, and output to the positive electrode line PL1 and the negative electrode line NL.

Furthermore, by activating the power feeding inverter 40, the direct current power output to the positive electrode line PL1 and the negative electrode line NL can be converted into alternating current power while the vehicle 100 is stationary. Hence, the vehicle 100 is capable of supplying at least one of the power discharged by the storage apparatus B and the power generated by the motor generator MG 1 from the power outlet 35 and/or the inlet 60. As a result, power can be fed from the vehicle 100 to an electric device connected to the power outlet 35, or to an electric load or a household electrically connected to the inlet 60. In other words, power feeding from the vehicle 100 is realized using at least one of the power discharged from the storage apparatus B and the power generated by activating the engine 2.

The relay RY1 is closed during external charging of the vehicle 100, and open during a vehicle operation and a power feeding operation. The relay RY2 is closed during the power feeding operation performed by the vehicle 100, and open during a vehicle operation. When the relay RY2 is closed during external charging, the electric device connected to the power outlet 35 can be operated during external charging by the power supplied to the inlet 60. Accordingly, the power feeding inverter 40 shown in FIG. 2 corresponds to an embodiment of a “power feeding unit”.

The controller 50 is constituted by an electronic control unit (ECU), for example. The controller 50 determines a target driving force to be transmitted to the drive wheel 6 on the basis of an accelerator depression amount, a brake depression amount, a vehicle speed, and so on during a vehicle operation. The controller 50 then controls the engine 2 and the motor generators MG1, MG2 to realize an operating condition in which the target driving force can be output efficiently.

Further, the controller 50 is capable of executing external charging and power feeding selectively in response to an instruction from the user when the vehicle is stationary by controlling the charger 30 or the power feeding inverter 40 and the relays RY1, RY2. More specifically, when the vehicle 100 is incorporated into the power supply system by being electrically connected to the charging/discharging station 200 via the inlet 60, as described above, the vehicle 100 can be charged externally with inexpensive power, power can be fed from the vehicle 100 to avoid peak rates, and power can be fed from the vehicle 100 during a power outage in the commercial power system 400. Alternatively, an equal amount of alternating current power to the commercial power system 400 can be fed from the power outlet 35 even with the single vehicle 100.

The vehicle 100 is further provided with a seat occupancy sensor 61, a camera 62, a reception unit 63, and an operating unit 65.

The seat occupancy sensor 61 detects seat occupancy by detecting a load exerted on a passenger seat, not shown in the drawings, of the vehicle 100. The controller 50 can detect the presence of the user in the vehicle cabin on the basis of an output from the seat occupancy sensor 61.

The camera 62 is constituted by an in-vehicle camera and/or a vehicle-exterior camera. The controller 50 can detect the presence of the user in or in the vicinity of the vehicle on the basis of an output from the camera 62.

A smart key 70 is configured to emit weak radio waves. The reception unit 63 receives the radio waves from the smart key 70. Hence, the controller 50 can detect the presence of the user in or in the vicinity of the vehicle on the basis of a radio wave reception condition of the reception unit 63.

The presence of the user (a passenger) within a predetermined range of the vehicle 100 can thus be detected using the seat occupancy sensor 61, the camera 62, and the reception unit 63. In other words, the seat occupancy sensor 61, the camera 62, and the reception unit 63 respectively correspond to embodiments of a “detector”. Note that the “detector” may be constituted by any device capable of detecting the presence of the user (a passenger) within a predetermined range of the vehicle 100.

Various user operations are input into the operating unit 65. For example, the operating unit 65 may be constituted by mechanical switches provided in the vehicle cabin and touch panels provided on various panels in the vehicle cabin.

In the vehicle 100 shown in FIG. 2, a “power generation mechanism” for generating power using an energy source other than the storage apparatus B may be constituted by the engine 2 and the motor generator MG1. During an operation of the power generation mechanism, the engine 2 is activated, and therefore operating noise and exhaust heat are output to the periphery of the vehicle 100.

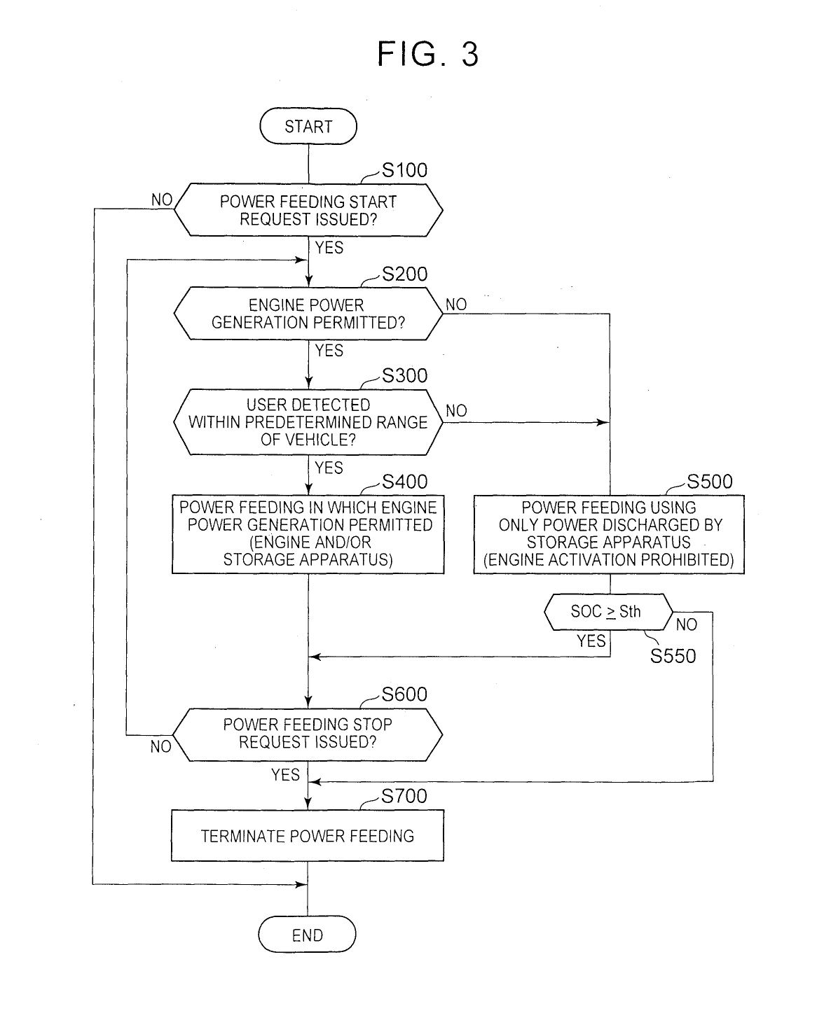

The power feeding operation performed by the vehicle 100 will be described in detail below. FIG. 3 is a flowchart illustrating in detail the power feeding operation performed by the vehicle 100 shown in FIG. 2. Control processing illustrated in the flowchart of FIG. 3 is executed by the controller 50, for example.

Referring to FIG. 3, in step S100, the controller 50 determines whether or not a power feeding start request has been issued in relation to the vehicle 100. A power feeding start request is issued in relation to the vehicle 100 in response to a user operation input into the operating unit 65 or a user operation input on the side of the charging/discharging station 200 or the house 300, for example. When a power feeding start request has not been issued (when the determination of S100 is negative), the controller 50 does not execute following steps S200 to S700.

When a power feeding start request has been issued (when the determination of S100 is affirmative), the processing advances to step S200, where the controller 50 determines whether or not power generation through activation of the engine 2 (referred to simply as “engine power generation” hereafter) has been permitted by the user. For example, the operating unit 65 is configured to be capable of receiving an instruction from the user indicating whether or not engine power generation is permitted.

Furthermore, in step S200, a determination is made on the basis of a condition of the engine 2, a remaining fuel amount, and so on as to whether or not engine power generation can be executed. In other words, when the remaining fuel amount is insufficient or the engine 2 cannot be activated due to a fault or the like, a negative determination is made in step S200 even if engine power generation has been permitted by the user.

When engine power generation has been permitted by the user and the engine 2 can be activated without impediment, an affirmative determination is made in step S200. When engine power generation has not been permitted by the user, on the other hand, a negative determination is made in step S200 even if the engine 2 can be activated without impediment.

When engine power generation is permitted (when the determination of S200 is affirmative), the processing advances to step S300, where the controller 50 determines whether or not the user (a passenger) has been detected within the predetermined range of the vehicle 100. The determination of step S300 is made on the basis of the output of at least one of the seat occupancy sensor 61, the camera 62, and the reception unit 63, shown in FIG. 2.

When the user has been detected within the predetermined range of the vehicle 100 (when the determination of S300 is affirmative), the processing advances to step S400, where the controller 50 executes power feeding in which engine power generation is permitted. As a result, the vehicle 100 feeds power generated by activating the engine 2 (the power generation mechanism) and/or power discharged from the storage apparatus B from the power outlet 35 and/or the inlet 60.

When, on the other hand, the user has not permitted engine power generation (when the determination of S200 is negative) or the user has not been detected within the predetermined range of the vehicle (when the determination of S300 is negative), the processing advances to step S500, where the controller 50 executes power feeding using only the power discharged from the storage apparatus B. In other words, activation of the engine 2 (the power generation mechanism) is prohibited.

When power feeding is performed using only the power discharged from the storage apparatus B, the controller 50 compares the SOC of the storage apparatus B with a determination value Sth in step S550. When the SOC falls below the determination value Sth (when the determination of 5550 is negative), the processing advances to step S700, where the controller 50 terminates the power feeding operation.

When SOC≧Sth (when the determination of S550 is affirmative), the processing advances to step S600, where the controller 50 determines whether or not a power feeding stop request has been issued. When a power feeding stop request has not been issued (when the determination of S600 is negative), the controller 50 returns to the processing of step S200. Hence, power feeding using only the power discharged from the storage apparatus B (S500) is continued until the SOC of the storage apparatus B falls below the determination value Sth.

The controller 50 determines whether or not a power feeding stop request has been issued in step S600 likewise during power feeding in which engine power generation is permitted (S500). Similarly to the power feeding start request, the power feeding stop request can be generated in response to a user operation input into the operating unit 65 or a user operation input on the side of the charging/discharging station 200 or the house 300.

When a power feeding stop request has not been issued (when the determination of S600 is negative), the controller 50 returns to the processing of step S200. Hence, power feeding in which engine power generation is permitted is continued until a power feeding stop request is issued. Note that when the remaining fuel amount decreases or the user cancels the permission for engine power generation during power feeding, the determination of step S200 becomes negative, and therefore activation of the engine 2 is prohibited (S500). Accordingly, the power feeding operation is switched to power feeding using only the power discharged from the storage apparatus B (S500).

Further, when the user moves away from the vehicle 100 during power feeding in combination with engine power generation, the determination of step S300 becomes negative, and therefore activation of the engine 2 is prohibited (S500). Accordingly, the power feeding operation is switched to power feeding using only the power discharged from the storage apparatus B (S500).

When a power feeding stop request is issued (when the determination of S600 is affirmative), the processing advances to step S700, where the controller 50 terminates power feeding from the vehicle 100. As a result, the operation of the power feeding inverter 40 is stopped. When engine power generation is underway, the engine 2 is also stopped. Furthermore, the system main relay SMR and the relay RY2 are opened.

Hence, with the vehicle and the power supply system according to this embodiment, when the presence of the user is not detected within the predetermined range of the vehicle 100 (when the user is absent), activation of the engine 2 (the power generation mechanism), during which operating noise and exhaust heat are generated, can be prohibited. As a result, effects unintended by the user on the periphery of the vehicle, which occur when the engine (the power generation mechanism) is activated automatically in order to generate power while the user is absent, can be avoided.

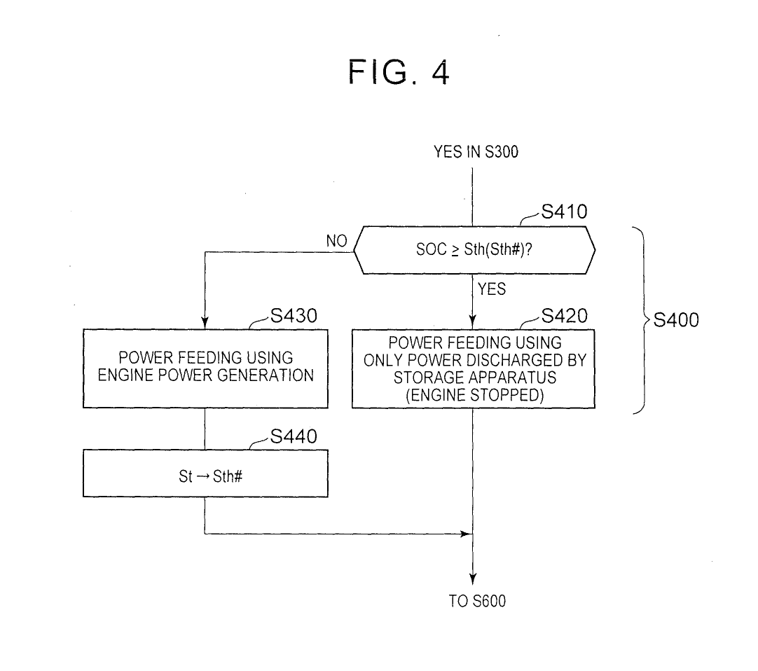

FIG. 4 is a flowchart illustrating a control operation performed during power feeding in combination with engine power generation, corresponding to step S400 in FIG. 3.

Referring to FIG. 4, step S400 shown in FIG. 3 includes steps S410 to S440.

When the determination of step S300 (FIG. 3) is affirmative, or in other words when engine power generation is permitted and the user has been detected within the predetermined range of the vehicle 100, the processing advances to step S410, where the controller 50 compares the SOC of the storage apparatus B with a determination value. The determination value used in step 5410 is identical to the determination value Sth used in step S550 (S550) when the engine 2 is stopped. In other words, at the start of engine power generation, the determination value of S410 is set at Sth.

When SOC Sth (when the determination of S410 is affirmative), the processing advances to step 5420, where the controller 50 executes power feeding using only the power discharged from the storage apparatus B, similarly to step S500 (FIG. 3). In other words, the engine 2 is stopped.

When SOC<Sth (when the determination of S410 is negative), on the other hand, the processing advances to step S430, where the controller 50 performs power feeding using engine power generation. Accordingly, the engine 2 is activated such that power is supplied from the power outlet 35 and/or the inlet 60 using the power generated by the power generation mechanism. Further, while the engine is activated, the processing advances to step S440, where the controller 50 increases the determination value of step S410 from Sth to Sth# (Sth#>Sth).

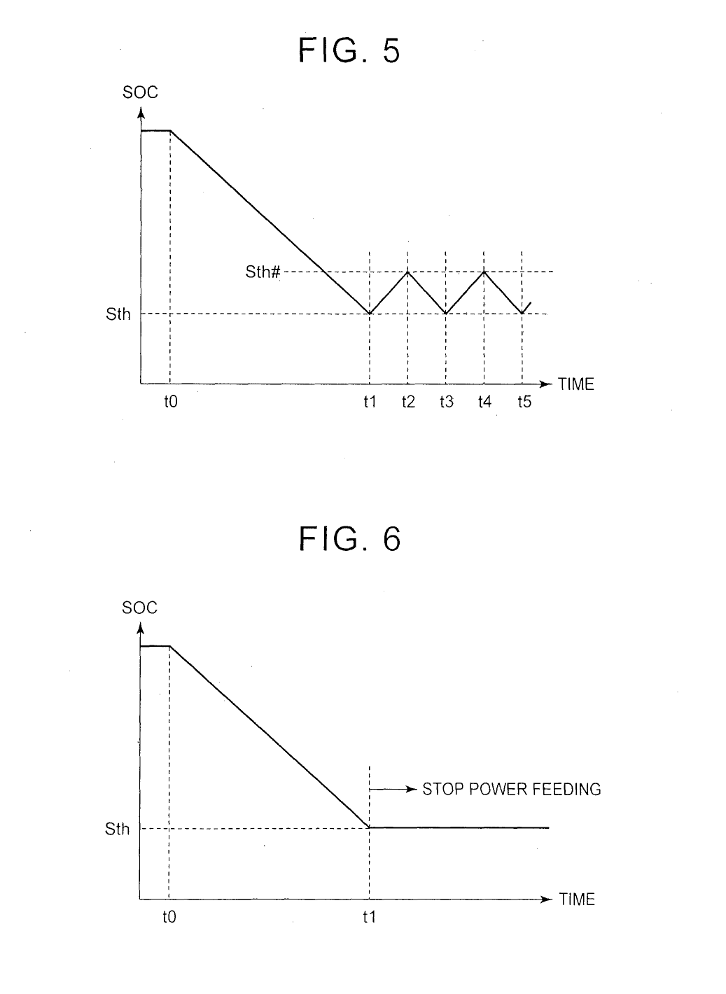

FIG. 5 is a conceptual waveform diagram illustrating the power feeding operation shown on the flowchart of FIG. 4. FIG. 5 shows a power feeding operation in which engine power generation is permitted (the determination of S200 is affirmative) and the user has been detected within the predetermined range of the vehicle 100 (the determination of S300 is affirmative).

Referring to FIG. 5, when power feeding is started at a time t0, the SOC is higher than the determination value Sth from the time t0 to a time t1, and therefore power feeding is executed using only the power discharged by the storage apparatus B. As a result, the SOC of the storage apparatus B gradually decreases.

When the SOC falls below the determination value Sth at the time t1, discharge from the storage apparatus B is stopped. Since engine power generation is permitted, however, the engine 2 is activated so that power generation by the power generation mechanism is started. Hence, from the time t1, power is output from the power outlet 35 and/or the inlet 60 using the power generated by the power generation mechanism while the engine 2 is activated. The storage apparatus B is charged with surplus power obtained by subtracting the power consumption from the power outlet 35 and/or the inlet 60 from the power generated by the power generation mechanism. Therefore, the SOC of the storage apparatus B increases during engine power generation.

When the SOC increases above the determination value Sth# at a time t2, the engine 2 is stopped such that the vehicle 100 again performs power feeding using only the power discharged by the storage apparatus B.

Power feeding using only the power discharged by the storage apparatus B is then continued from the time t2 to a time t3, at which the SOC falls below Sth again. Thereafter, power feeding using engine power generation (from the time t3 to a time t4) and power feeding using only the power discharged by the storage apparatus B (from the time t4 to a time t5) are executed alternately in a similar fashion.

Hence, during power feeding in which engine power generation is permitted, while use of the power stored in the storage apparatus B is prioritized, power feeding from the vehicle 100 can be executed through engine power generation when the SOC decreases.

FIG. 6, on the other hand, shows a power feeding operation in which engine power generation is prohibited. As described above, when the user has not permitted engine power generation (when the determination of S200 is negative) or when the user has not been detected within the predetermined range of the vehicle (when the determination of S300 is negative), engine power generation is prohibited.

Referring to FIG. 6, when power feeding is started at a time t0, the SOC is higher than the determination value Sth, and therefore power feeding is executed using only the power discharged by the storage apparatus B. Hence, from the time t0 onward, power is output from the power outlet 35 and/or the inlet 60 of the vehicle 100 while the SOC of the storage apparatus B decreases.

When the SOC falls below the determination value Sth at a time t1, discharge from the storage apparatus B is stopped. Therefore, when the SOC falls below the determination value Sth in a case where engine power generation is prohibited, power feeding from the vehicle 100 is terminated. In other words, from the time t1 onward, no power is output from the power outlet 35 and/or the inlet 60 of the vehicle 100.

Hence, in the vehicle and the power supply system including the vehicle according to this embodiment of the invention, power feeding from the storage apparatus B is prioritized even when the user is within the predetermined range of the vehicle 100 such that power feeding in combination with engine power generation is permitted. As a result, power feeding can be executed from the vehicle while suppressing activation of the engine 2.

Note that in this embodiment, a configuration in which the charger 30 and the power feeding inverter 40 are disposed separately is shown in FIG. 2 as an embodiment of the power feeding function of the vehicle. However, the functions of both the charger 30 and the power feeding inverter 40 may be realized by a single power converter that performs bidirectional AC/DC conversion. The configuration for converting the direct current power output from the power generation mechanism and/or the storage apparatus B to the positive electrode line PL1 and the negative electrode line NL into alternating current power is not limited to these examples, and any desired configuration may be employed. For example, the vehicle 100 may be configured such that a direct current/alternating current (DC/AC) converter is constituted by the inverters 21, 22 and stator coils of the motor generators MG1, MG2, whereby alternating current power is output between neutral points of the respective stator coils.

Furthermore, the manner in which power is fed from the vehicle is not limited to the examples shown in FIG. 2, namely power feeding to the exterior located outside the vehicle via the power cable 250 and power feeding from the power outlet 35 provided in the vehicle cabin, and the invention may be applied to power feeding performed in another manner. For example, power may be fed by providing the charging/discharging connector 220 with a power outlet for extracting alternating current power. Alternatively, power may be fed from the vehicle in a non-contact fashion using an electromagnetic coupling, without the need for a direct electric connection.

Moreover, the power generation mechanism of the vehicle may be formed from a so-called series hybrid type configuration including a specialized power generating engine and a power generator, rather than the engine 2 and the motor generator MG1 of the vehicle 100 shown in FIG. 2. Alternatively, the power generation mechanism may be formed using a fuel cell instead of an engine. In other words, the vehicle to which the invention is applied may be a fuel cell vehicle. Likewise in a fuel cell vehicle, operating noise is generated when water generated during a hydrogen reaction of the fuel cell is discharged by an accessory such as a pump. Similarly to an engine, therefore, depending on the parking condition of the vehicle and the time of day, the periphery of the vehicle may be affected by noise generation and so on in a manner unintended by the user. Hence, in the vehicle and the power supply system to which the invention is applied, the power generation mechanism may be constituted by any apparatus that generates power using a different energy source from the storage apparatus, for example an engine or a fuel cell.

The embodiments disclosed herein are to be considered in all aspects exemplary and not limiting. The scope of the invention is defined by the claims rather than the above description, and is intended to include all equivalent definitions to the claims and all modifications within the scope thereof.

1. A vehicle comprising:
a storage apparatus configured to be recharged;
a power generation mechanism configured to generate power using a different energy source from the storage apparatus;
a power feeding apparatus configured to supply power obtained from at least one of the storage apparatus and the power generation mechanism, from the vehicle;
a detector configured to detect a user within a predetermined range of the vehicle; and
a controller configured to prohibit power generation by the power generation mechanism when a request for power feeding from the vehicle is issued and the user has not been detected within the predetermined range.

2. The vehicle according to claim 1, wherein, the controller activates the power generation mechanism and the power feeding apparatus feeds the power obtained from the power generation mechanism from the vehicle, when a state of charge of the storage apparatus is lower than a first determination value and the user has been detected within the predetermined range while the request for power feeding from the vehicle is issued.

3. The vehicle according to claim 2, wherein, the controller stops the power generation by the power generation mechanism and the power feeding apparatus feeds the power obtained from the storage apparatus from the vehicle, when the state of charge exceeds a second determination value while power generation by the power generation mechanism is underway, the second determination value is larger than the first determination value.

4. The vehicle according to claim 1, wherein, the controller prohibits power feeding from the vehicle, when a state of charge of the storage apparatus is lower than a first determination value and the user has not been detected within the predetermined range.

5. The vehicle according to claim 1, further comprising:
a connection port configured to electrically connect the vehicle to an exterior located outside the vehicle,
wherein the power feeding apparatus is configured to supply power to the exterior located outside the vehicle through the connection port.

6. The vehicle according to claim 1, further comprising:
a power outlet provided in a vehicle cabin,
wherein the power feeding apparatus is configured to supply power from the power outlet.

7. The vehicle according to claim 1, wherein the power generation mechanism includes an engine that generates power by burning fuel, and a motor generator that generates power using an output of the engine.

8. A power supply system comprising:
a vehicle including:
a cable connection port,
a storage apparatus configured to be recharged,
a power generation mechanism configured to generate power using a different energy source from the storage apparatus,
a first power feeding apparatus configured to supply power obtained from at least one of the storage apparatus and the power generation mechanism to the cable connection port,
a detector configured to detect a user within a predetermined range of the vehicle, and
a controller configured to prohibit power generation by the power generation mechanism when the user is not detected within the predetermined range; and
a second power feeding apparatus configured to supply power supplied from the vehicle to a load located outside the vehicle, the second power feeding apparatus being configured to be electrically connected to the cable connection port via a power cable when a charging-discharging connector provided on the power cable is connected to the cable connection port.

9. The power supply system according to claim 8, wherein the vehicle includes a power outlet provided in a vehicle cabin, and the first power feeding apparatus is configured to supply power from the power outlet.

10. The power supply system according to claim 8, wherein the vehicle includes a charger that converts power, supplied to the cable connection port from outside the vehicle via the charging-discharging connector and the power cable, into power to be charged to the storage apparatus.
